(19) United States
(12) Patent Application Publication
(10) Pub. No.: US 2011/0128506 A1
(43) Pub. Date: Jun. 2, 2011

(54) LASER BEAM SOURCE DEVICE, PROJECTOR, AND MONITORING DEVICE

(75) Inventor: Kunihiko TAKAGI, Okaya-shi (JP)

(73) Assignee: SEIKO EPSON CORPORATION, Tokyo (JP)

(21) Appl. No.: 12/897,212

(22) Filed: Oct. 4, 2010

(30) Foreign Application Priority Data
Nov. 27, 2009 (JP) 2009-269667

(51) Int. Cl. G03B 21/00; G02B 27/10

(52) U.S. Cl. 353/31; 359/618

(57) ABSTRACT

A laser beam source device includes: a first light emission element which has a light emission portion for emitting a laser beam; a second light emission element which has a light emission portion for emitting a laser beam; a control member which has a flat surface on which the first light emission element is disposed and a curved surface having a convexed part; and a holding member which has a concaved portion formed in correspondence with the curved surface for engagement between the concaved portion and the control member, wherein the first light emission element and the second light emission element are disposed such that light emitted from the light emission portion of each of the first and second light emission elements enter the light emission portion of the other light emission element.

### BACKGROUND

1. Technical Field

The present invention relates to a laser beam source device, a projector, and a monitoring device.

2. Related Art

A high-pressure mercury lamp has been often used as an illumination light source of an optical apparatus such as a projector. However, the high-pressure mercury lamp has several problems such as limited color reproducibility, insufficient rapidity in lighting, and short life. For solving these problems, a laser beam source device applicable in this field has been under development. Particularly, a laser beam source device having an external resonator structure capable of intensifying light having a particular wavelength by using an external resonating mirror has been developed to produce high output. In addition, a technology which generates light having a fundamental wavelength such as an infrared laser beam and then converts the infrared laser beam into visible light having a ½ wavelength by using a wavelength converging element such as a second harmonic generator (hereinafter abbreviated as SHG) has been employed.

According to this technology, the laser beam needs to be amplified by successive inductive discharge generated through reciprocation of the laser beam many times within a laser generator. However, when the optical axis of the laser beam deviates even only slightly, sufficient reciprocation of the laser beam cannot be achieved. In this case, lasers cannot be generated. According to the external resonator type laser beam source device, therefore, alignment (position matching) between a laser diode including an emitter (light emission portion) and an external resonating mirror is extremely important, and sufficient output cannot be produced when alignment accuracy is low. For preventing lowering of alignment accuracy caused by thermal lensing effect of a laser excitation medium, a method which uses a concaved reflection surface of an external resonating mirror has been proposed (for example, see JP-A-2004-363414). According to the description of this reference, the output laser beam reflected by the concaved reflection surface of the external resonating mirror returns toward the optical axis even when the laser beam expands or deviates by the thermal lensing effect of the laser excitation medium. By this method, sufficient output is expected to be produced.

However, even when sufficient alignment accuracy is secured between the laser excitation medium and the external resonating mirror by using the method disclosed in JP-A-2004-363414, increase in the output of the laser is still limited. For further increasing the output, an external resonator structure which includes two laser diodes disposed optically opposed to each other has been studied. According to this external resonator structure, the laser diodes are provided at both ends of the resonator, and laser beams are amplified by successive inductive discharge generated through reciprocation of the laser beams between the two laser diodes. In this structure, the external resonating mirror is not required, and thus the size of the device can be reduced. Moreover, the amplification of the laser beams is expected to be larger than that of a structure including the external resonating mirror, which allows the laser beam source device to be appropriate for high output.

According to this external resonator structure, however, emitters of the two laser diodes need to be accurately aligned for generating sufficient lasers. Thus, when the center axes of the laser beams emitted from the respective laser diodes deviate from each other even slightly, sufficient reciprocation of the laser beams cannot be achieved. In this case, lasers cannot be generated, or loss of the light amount is produced by inaccurate return of the laser beams toward the laser diodes. Therefore, the light source device provided with the external resonator structure which includes the two laser diodes disposed optically opposed to each other is difficult to be manufactured, and the output is lowered under the condition that the laser beams do not return to the laser diodes disposed opposed to each other with sufficient accuracy.

### SUMMARY

An advantage of some aspects of the invention is to provide a laser beam source device, a projector, and a monitoring device, as a technology associated with a laser beam source provided with a resonator structure which contains light emission elements opposed to each other and capable of achieving high output.

A laser beam source device according to an aspect of the invention includes: a first light emission element which has a light emission portion for emitting a laser beam; a second light emission element which has a light emission portion for emitting a laser beam; a control member which has a flat surface on which the first light emission element is disposed and a curved surface having a convexed part; and a holding member which has a concaved portion formed in correspondence with the curved surface for engagement between the concaved portion and the control member. The first light emission element and the second light emission element are disposed such that light emitted from the light emission portion of each of the first and second light emission elements enter the light emission portion of the other light emission element.

According to the laser beam source device of this aspect of the invention, the holding member has the concaved portion formed in correspondence with the curved surface of the control member, and the control member engages with the concaved portion. In this structure, angles around three axes are adjusted by sliding the control member on the holding member, and then the control member is fixed to the holding member. By this method, a DBR layer of the first light emission element and a DBR layer of the second light emission element can be disposed in parallel with each other, allowing the laser beam emitted from the light emission portion of each of the first light emission element and the second light emission element to enter the light emission portion of the other light emission element.

According to this structure in which the control member slides on the holding member, almost no clearance is produced between the control member and the holding member when the first light emission element is fixed after adjustment of the angle of the first light emission element. In this case, the angle of the light emission element does not change with the elapse of time after the control member is fixed to the holding member by an adhesive, for example. Thus, the laser beam emitted from the light emission portion of the first light emission element can accurately enter the light emission portion of the second light emission element. Accordingly, highly reliable and high-output laser beams can be produced.

It is preferable that the laser beam source device of the aspect of the invention further includes; a supporting member on which the second light emission element is disposed; and a space member which allows the first light emission element and the second light emission element to be disposed opposed to each other and maintains a predetermined distance between the first light emission element and the second light emission element.

According to the laser beam source device, the space member is provided between the holding member having the control member on which the first light emission element is disposed and the supporting member on which the second light emission element is disposed. Thus, the first light emission element and the second light emission element can be disposed opposed to each other with a predetermined distance provided between the first and second light emission elements. Moreover, even when sufficient laser beams emitted from the light emission portion of each of the first light emission element and the second light emission element cannot be supplied to the light emission portion of the other light emission element only by disposing the DBR layer of the first light emission element and the DBR layer of the second light emission element such that the two DBR layers become parallel with each other, the laser beam emitted from the light emission portion of each of the first and second light emission elements can be accurately supplied to the light emission portion of the other light emission element by controlling the position of the holding member or the supporting member within the plane of the end surface of the space member in this structure. Thus, the first light emission element and the second light emission element can be disposed in such positions as to generate lasers with high efficiency.

It is preferable that the laser beam source device of the aspect of the invention satisfies the following point: the space member achieves fine adjustment of the distance between the first light emission element and the second light emission element.

The optimum distance between the first light emission element and the second light emission element varies according to the differences of the individual bodies of the first and second light emission elements produced during manufacture. According to this laser beam source device, the predetermined distance between the first light emission element and the second light emission element is maintained and finely adjusted by using the space member. Thus, the first light emission element and the second light emission element can be disposed with a distance provided between the first and second light emission elements as a length for allowing laser generation with the highest possible efficiency.

It is preferable that the laser beam source device of the aspect of the invention further includes a dividing unit which releases a part of entering laser beams in a direction different from directions toward the first light emission element and the second light emission element and releases the remaining part of the laser beams in directions toward the first light emission element and the second light emission element.

According to this laser beam source device which includes the dividing unit, the laser beams can be extracted to the outside from the optical path between the first light emission element and the second light emission element.

It is preferable that the laser beam source device of the aspect of the invention further includes a wavelength converting element which receives laser beams having a fundamental wavelength and emitted from the first light emission element and the second light emission element, and converts at least a part of the laser beams having the fundamental wavelength into laser beams having a predetermined converted wavelength.

According to this laser beam source device, at least a part of the laser beams having the fundamental wavelength and emitted from the first and second light emission elements are converted into laser beams having the predetermined converted wavelength while passing through the wavelength converting element. In this case, infrared laser beams can be converted into visible laser beams, for example, by using the wavelength converting element. Thus, laser beams having a desired wavelength can be produced.

It is preferable that the laser beam source device of the aspect of the invention satisfies the following points: the dividing unit has a first dividing unit disposed on an optical path between the first light emission element and the wavelength converting element and a second dividing unit disposed on an optical path between the second light emission element and the wavelength converting element; and the first and second dividing units release the laser beams converted into laser beams having the predetermined converted wavelength in directions different from directions toward the first light emission element and the second light emission element, and release the laser beams not converted into laser beams having the predetermined wavelength in directions toward the first light emission element and the second light emission element.

According to this laser beam source device, the laser beams converted into laser beams having the predetermined converted wavelength by using the wavelength converting element are released in direction different from directions toward the first and second light emission elements by the function of the first and second dividing units. The laser beams not converted into laser beams having the predetermined converted wavelength are released toward the first and second light emission elements. Accordingly, the laser beams converted into laser beams having the predetermined converted wavelength can be efficiently extracted by using the first and second dividing units.

A projector according to another aspect of the invention includes: the laser beam source device described above; a light modulation device which modulates a laser beam emitted from the laser beam source device according to an image signal; and a projection device which projects light modulated by the light modulation device.

According to the laser projector of this aspect of the invention, light emitted from the laser beam source device enters the light modulation device. Then, the image formed by the laser beam modulation device is projected by the projection device. Since the light emitted from the light source device is constituted by high-output laser beams as described above, bright and clear images can be displayed.

A monitoring device according to still another aspect of the invention includes: the laser beam source device described above; and an image pickup unit which captures an image of a subject by using a laser beam emitted from the laser beam source device.

According to the monitoring device of this aspect of the invention, the laser beams emitted from the laser beam source device are applied to the subject, and the image of the subject is captured by the image pickup unit. Since the laser beams are constituted by high-output laser beams as described above, bright light is applied to the subject. Thus, a clear image of the subject can be captured by the image pickup unit.

### BRIEF DESCRIPTION OF THE DRAWINGS

The invention will be described with reference to the accompanying drawings, wherein like numbers reference like elements.

FIG. 1 is a cross-sectional view illustrating the main part of a laser beam source device according to a first embodiment of the invention.

FIG. 2A is a plan view of first and second light emission elements shown in FIG. 1.

FIG. 2B is a side view of the first and second light emission elements shown in FIG. 1.

FIG. 3 is a perspective view illustrating a space member shown in FIG. 1.

FIG. 4 is a cross-sectional view illustrating the main part of a laser beam source device according to a second embodiment of the invention.

FIG. 5 illustrates the general structure of a projector according to a third embodiment of the invention.

FIG. 6 illustrates the general structure of a scanning-type image display apparatus according to a fourth embodiment of the invention.

FIG. 7 illustrates the general structure of a monitoring device according to a fifth embodiment of the invention.

### DESCRIPTION OF EXEMPLARY EMBODIMENTS

A laser beam source device, a projector, and a monitoring device embodying the invention are hereinafter described with reference to the drawings. In the figures referred to herein, the reduction scales of the respective components are varied as necessary for easily recognizing the components in the figures.

### First Embodiment

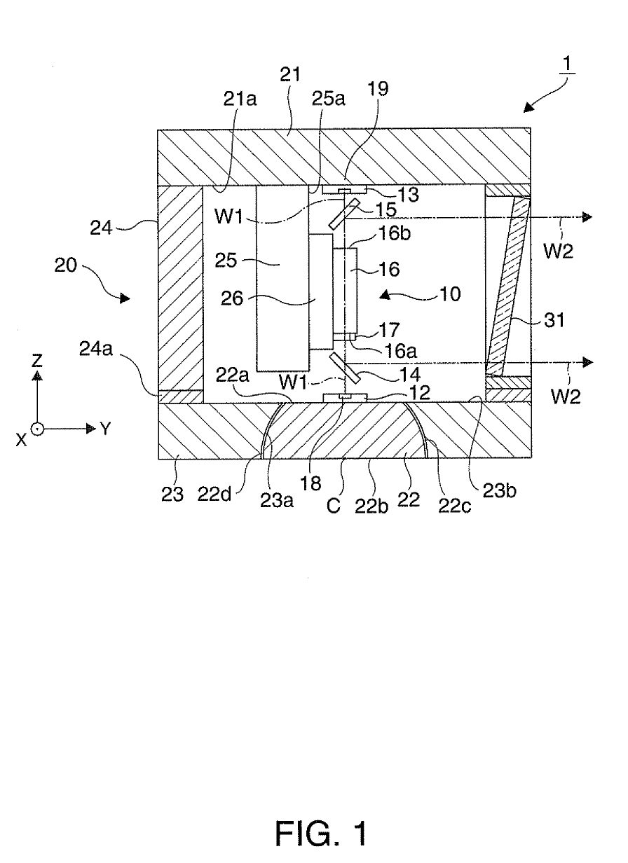

As illustrated in FIG. 1, a laser beam source device 1 includes an optical system 10 and a holding unit 20.

The optical system 10 has a first semiconductor laser element (first light emission element) 12, a second semiconductor laser element (second light emission element) 13, a first dichroic mirror (dividing unit: first dividing unit) 14, a second dichroic mirror (dividing unit: second dividing unit) 15, a wavelength converting element 16, and a BPF (wavelength selecting element) 17.

The emission directions of laser beams emitted from the first and second semiconductor laser elements 12 and 13 correspond to a Z axis direction, the arrangement directions of emitters 18 and 19 described later correspond to an X axis direction, and the axis crossing the emission directions and the arrangement directions at right angles corresponds to a Y axis direction.

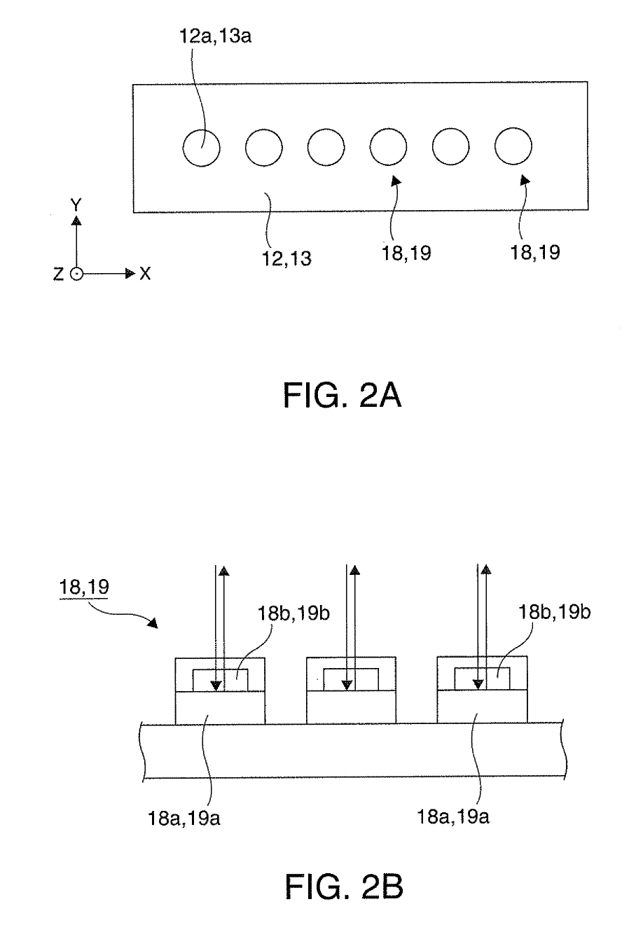

As illustrated in FIG. 2A, each of the first and second semiconductor laser elements 12 and 13 is a face-emission-type laser diode which emits infrared laser beams having a wavelength of 1,060 nm (lights having a fundamental wavelength) from emission end surfaces 12a and 13a, for example, and a plurality of substantially circular emitters (light emission portions) 18 and 19 in the plan view are formed on the first and second semiconductor laser elements 12 and 13, respectively. More specifically, the first and second semiconductor laser elements 12 and 13 have the plural emitters 18 and 19 in the X axis direction. The plural (six in the example of the figure) emitters 18 of the first semiconductor laser element 12 and the plural (six in the example of the figure) emitters 19 of the second semiconductor laser element 13 are provided with one-to-one correspondence.

As illustrated in the enlarged view in FIG. 2B, each of the emitters 18 has an active layer 18b laminated on a DBR (distributed Bragg reflector) layer 18a. Similarly to the emitters 18, each of the emitters 19 has an active layer 19b laminated on a DBR layer 19a.

In this arrangement, laser beams emitted from the first semiconductor laser element 12 enter the second semiconductor laser element 13, and laser beams emitted from the second semiconductor laser element 13 enter the first semiconductor laser element 12. By this method, lasers are generated through reciprocation of the laser beams between the first semiconductor laser element 12 and the second semiconductor laser element 13. Thus, the first and second semiconductor laser elements 12 and 13 constitute a laser beam source.

As can be seen from FIG. 1, the wavelength converting element 16 is disposed between the first dichroic mirror 14 and the second dichroic mirror 15. The wavelength converting element 16 is located at such a position as to receive all laser beams emitted from the plural emitters 18 through an end surface 16a and receive all laser beams emitted from the plural emitters 19 through an opposite end surface 16b.

The wavelength converting element 16 is constituted by PPLN (periodically poled lithium niobate) as a non-linear optical element, and functions as SHG which converts at least a part of entering light into light having a substantially half wavelength and generates second higher harmonic waves.

As illustrated in FIG. 1, a part of light emitted from the first semiconductor laser element 12 and supplied toward the second semiconductor laser element 13 is converted into green laser beams having a substantially half wavelength (530 nm) (light having a predetermined converted wavelength) while passing through the wavelength converting element 16. Similarly, a part of light emitted from the second semiconductor laser element 13 and supplied toward the first semiconductor laser element 12 is converted into green laser beams.

As illustrated in FIG. 1, the first and second dichroic mirrors 14 and 15 are mirrors which receive the laser beams emitted from the plural emitters 18 and 19, transmit infrared laser beams toward the first and second semiconductor laser elements 12 and 13, and reflect visible lights in directions different from directions toward the first and second semiconductor laser elements 12 and 13.

The first dichroic mirror 14 is disposed in such a direction as to receive the laser beam emitted from the wavelength converting element 16 at approximately 45 degrees. Similarly, the second dichroic mirror 15 is disposed in such a direction as to receive the laser beam emitted from the wavelength converting element 16 at approximately 45 degrees.

In this arrangement, the infrared laser beam emitted from the first semiconductor laser element 12, sequentially transmitted by the first dichroic mirror 14 and the wavelength converting element 16, and not converted into a green laser beam is transmitted by the second dichroic mirror 15 and supplied to the second semiconductor laser element 13. In this case, an infrared laser beam W1 emitted from the first semiconductor laser beam element 12 resonates between the DBR layer 18a of the first semiconductor laser element 12 and the DBR layer 19a of the second semiconductor laser element 13 to be amplified. The infrared laser beam W1 emitted from the second semiconductor laser element 13 is amplified in the similar manner.

On the other hand, laser beams W2 supplied from the first and second semiconductor laser elements 12 and 13 and converted into green laser beams while passing through the wavelength converting element 16 are reflected by the first dichroic mirror 14 or the second dichroic mirror 15 in the Y axis direction.

The BPF (band-pass filter) 17 is disposed between the first dichroic mirror 14 and the wavelength converting element 16. The BPF 17 transmits only light having a predetermined converted wavelength to limit the spectrum of the emission wavelength. Thus, the green laser beam can be outputted in a stable manner by the function of the BPF 17.

As illustrated in FIG. 1, the holding unit 20 has a supporting substrate (supporting member) 21, a spherical base (control member) 22, a holding base (holding member) 23, a space member 24, a tower member 25, and a temperature control substrate 26.

The supporting substrate 21 is a component having a flat plate shape, and has an upper surface 21a on which the second semiconductor laser element 13 is disposed.

The spherical base 22 has a shape which contains a flat surface 22a produced by linearly cutting a part of a sphere, and side surfaces 22c and 22d as convexly curved surfaces. The first semiconductor laser element 12 is disposed on the flat surface 22a. The spherical base 22 has another flat surface 22b parallel with the flat surface 22a, but the flat surface 22b is not essential to this structure.

A through hole 23a is formed on a part of the holding base 23. The through hole 23a is a concave portion shaped in correspondence with the side surfaces 22c and 22d of the spherical base 22, and the spherical base 22 engages with the through hole 23a to be fixed thereto. The spherical base 22 is disposed such that the flat surface 22a of the spherical base 22 faces an upper surface 23b of the holding base 23.

The holding base 23 holds the spherical base 22 such that the spherical base 22 can slide on the holding base 23, that is, the spherical base 22 can freely rotate around a center C of the spherical base 22. Since the holding base 23 is only required to hold the spherical base 22 such that the spherical base 22 can slide on the holding base 23, almost no clearance is produced between the holding base 23 and the spherical base 22.

In this structure, the rotation of the first semiconductor laser element 12 around the X axis (θx), the Y axis (θy), and the Z axis (θz) can be controlled such that the DBR layer 18a of the first semiconductor laser element 12 and the DBR layer 19a of the second semiconductor laser element 13 can be disposed in parallel with each other, and that the laser beam emitted from the emitters of each of the first and second semiconductor laser elements 12 and 13 can enter the emitters of the opposite semiconductor laser element. After this adjustment is finished, the spherical base 22 is fixed to the holding base 23 by bonding, welding, brazing or other methods.

The supporting substrate 21 and the spherical base 22 are disposed such that the second semiconductor laser element 13 on the upper surface 21a of the supporting substrate 21 can be opposed to the first semiconductor laser element 12 on the flat surface 22a of the spherical base 22.

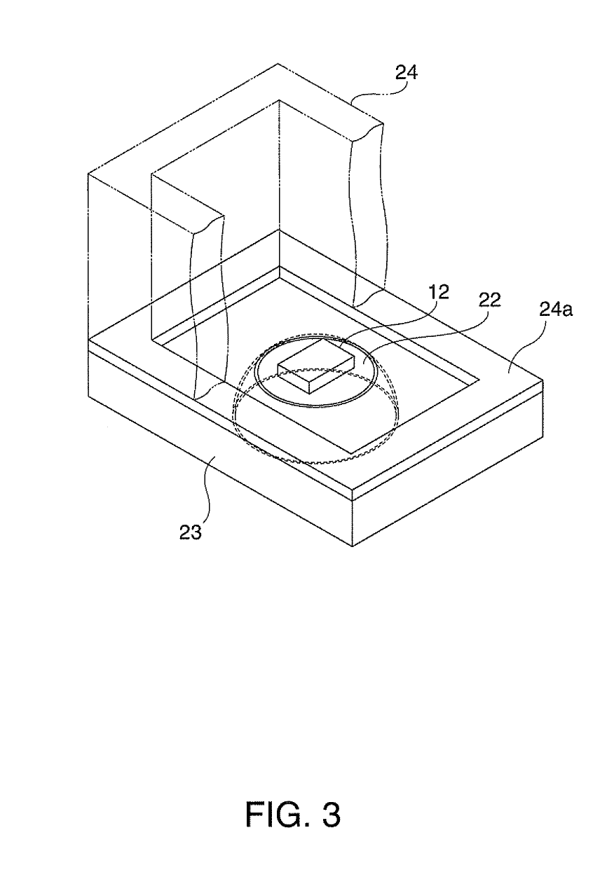

As illustrated in FIG. 1, the space member 24 is disposed on the upper surface 21a of the supporting substrate 21 and the upper surface 23b of the holding base 23. As can be seen from FIG. 3, the space member 24 has a shape of square enclosure and maintains a predetermined distance between the first semiconductor laser element 12 and the second semiconductor laser element 13. Moreover, the holding member 23 and the supporting member 21 fixed to the end surfaces of the space member 24 can be controlled in the X axis direction and the Y axis direction such that laser beams emitted from the light emission portions of each of the first and second light emission elements 12 and 13 can enter the light emission portions of the other light emission element with reduced loss. Furthermore, as illustrated in FIG. 1, a window 31 made of light transmissible material for transmitting the laser beams W2 reflected by the first and second dichroic mirrors 14 and 15 is provided at least a part of the space member 24 on the side for transmitting laser beams. Thus, the window 31 is a component for transmitting visible laser beams and reflecting or absorbing infrared laser beams.

According to the structure in this embodiment which includes the window 31 for reflecting infrared laser beams, the window 31 is disposed with inclination so as not to receive the laser beams W2 in the vertical direction. In this arrangement, the infrared laser beam having reached the window 31 is reflected in a direction other than the directions of the optical paths of the laser beams emitted from the first semiconductor laser element 12 and the second semiconductor laser element 13. Thus, interference between the infrared laser beam and the resonating laser beam can be prevented.

The space member 24 has a fine adjustment space member (space member) 24a disposed on the upper surface 23b of the holding base 23 for fine adjustment of the distance between the first semiconductor laser element 12 and the second semiconductor laser element 13. The distance between the first semiconductor laser element 12 and the second semiconductor laser element 13 (in the Z axis direction) can be controlled by using the fine adjustment space member 24a. After the positioning step, the fine adjustment space member 24a is fixed to the holding base 23 by a not-shown adhesive or solder.

As illustrated in FIG. 1, the tower member 25 extends from the upper surface 21a of the supporting substrate 21 toward the holding base 23. The temperature control substrate 26 is disposed on an upper surface 25a of the tower member 25.

The temperature control substrate 26 controls the temperatures of the first and second dichroic mirrors 14 and 15, the wavelength converting element 16, and the BPF 17. Particularly, the wavelength converting element 16 whose inside refractive index changes with variations of the temperature can convert the laser beams emitted from the first and second semiconductor laser elements 12 and 13 into higher harmonic wave laser beams having a predetermined wavelength when the temperature of the wavelength converting element 16 is appropriately controlled by using the temperature control substrate 26.

According to the laser beam source device 1 in this embodiment, therefore, the DBR layer 18a of the first semiconductor laser element 12 and the DBR layer 19a of the second semiconductor laser element 19a can be disposed in parallel with each other by sliding the spherical base 22 on the holding base 23 for rotation of the first semiconductor laser element 12 around the x axis (θx), the Y axis (θy), and the Z axis (θz). In this structure, almost no clearance is produced between the spherical base 22 and the holding base 23 at the time of rotational adjustment of the first semiconductor laser element 12. In this case, the positional shift of the first semiconductor laser element 12 produced by the change with elapse of time can be prevented after the spherical base 22 and the holding base 23 are fixed. Thus, the laser beams emitted from the emitters 18 of the first semiconductor laser element 12 can accurately enter the emitters 19 of the second semiconductor laser element 13. Accordingly, highly reliable and high-output laser beams can be produced.

The distance between the first semiconductor laser element 12 and the second semiconductor laser element 13 for emitting lasers with the highest efficiency varies by several hundred microns according to the differences of the individual bodies of the first and second semiconductor laser elements 12 and 13. According to this embodiment, the distance between the first semiconductor laser element 12 and the second semiconductor laser element 13 (Z axis direction) is adjustable by using the fine adjustment space member 24a before the two laser elements 12 and 13 are fixed. Thus, the first and second semiconductor laser elements 12 and 13 can be fixed at such positions that an optimum distance can be produced therebetween,

When the adjustment of the first and second semiconductor laser elements 12 and 13 in the Z axis direction is not required, the fine adjustment space member 24a can be eliminated.

While the structure of the laser beam source device 1 including the wavelength converting element 16 has been discussed in this embodiment, the wavelength converting element 16 may be eliminated.

### Second Embodiment

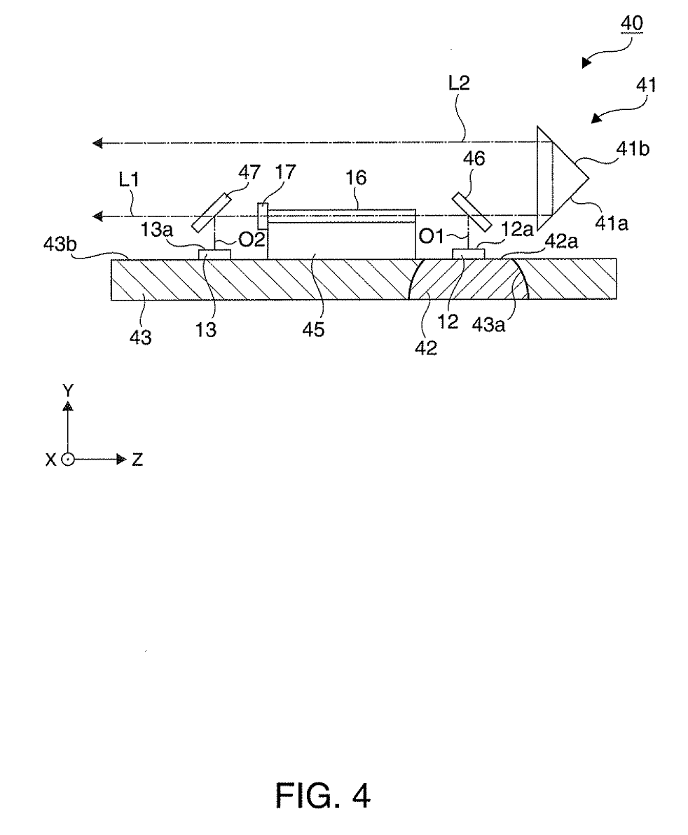

A second embodiment according to the invention is now described with reference to FIG. 4. In the figures associated with the respective embodiments, the same reference numbers are given to parts same as those of the laser beam source device 1 in the first embodiment, and the same explanation is not repeated.

A laser beam source device 40 in this embodiment is different from the laser beam source device 1 in the first embodiment in that the first and second semiconductor laser elements 12 and 13 are disposed at different positions, and that an optical path changing prism 41 is equipped. Other structures are similar to those in the first embodiment.

As illustrated in FIG. 4, a through hole 43a is formed on a holding base 43 similarly to the first embodiment, and a spherical base 42 engages with the through hole 43a. The first semiconductor laser element 12 is disposed on a flat surface 42a of the spherical base 42. In this arrangement, the rotation of the first semiconductor laser element 12 around the X axis (θx), the Y axis (θy), and the Z axis (θz) is controlled such that the laser beams emitted from the emitters of each of the first and second semiconductor laser elements 12 and 13 can enter the emitters of the other semiconductor laser element, and then the spherical base 42 is fixed to the holding base 43 by bonding, welding, brazing or other methods.

The wavelength converting element 16 is fixed to a temperature control substrate 45 disposed on an upper surface 43b of the holding base 43.

The second semiconductor laser element 13 is disposed on the upper surface 43b of the holding base (holding member) 43. Both the emission end surfaces 12a and 13a of the first and second semiconductor laser elements 12 and 13 face upward as viewed in the figure. That is, both the laser beams emitted from the first and second semiconductor laser elements 12 and 13 are directed upward in the Y axis direction.

First and second dichroic mirrors (dividing units: first and second dividing units) 46 and 47 are mirrors which reflect infrared laser beams (lights having a fundamental wavelength) toward the first and second semiconductor laser elements 12 and 13, and transmit visible laser beams (lights having a predetermined converted wavelength) in directions different from directions toward the first and second semiconductor laser elements 12 and 13.

The first dichroic mirror 46 is disposed on a center axis O1 of the laser beam emitted from the first semiconductor laser element 12 in such a position as to receive the laser beam at approximately 45 degrees. Similarly, the second dichroic mirror 47 is disposed on a center axis O2 of the laser beam emitted from the second semiconductor laser element 13 in such a position as to receive the laser beam at approximately 45 degrees.

The optical path changing prism 41 is fixed to the holding base 43, for example, by a not-shown holding member. The direction of the optical path of the light converted into light having the predetermined converted wavelength by the wavelength converting element 16 and transmitted by the first dichroic mirror 46 is changed to substantially the same direction as the direction of the laser beam having the predetermined converted wavelength and transmitted by the second dichroic mirror 47.

More specifically, the optical path changing prism 41 is a right-angled triangular prism which reflects the laser beam having passed through the first dichroic mirror 46 by a first surface 41a and further by a second surface 41b inclined to the first surface 41a at 90 degrees. Thus, the optical path changing prism 41 changes the optical path of the laser beam transmitted by the first dichroic mirror 46 through 180 degrees. As a result, a laser beam L1 transmitted by the second dichroic mirror 47 and a laser beam L2 transmitted by the first dichroic mirror 46 become substantially parallel with each other by the function of the optical path changing prism 41.

According to the laser beam source device 40 in this embodiment in which the first semiconductor laser element 12 is fixed after positioned by using the spherical base 42, the laser beam emitted from the first semiconductor laser element 12 enters the second semiconductor laser element 13, and the laser beam emitted from the second semiconductor laser element 13 enters the first semiconductor laser element 12. Thus, the laser beam source device 40 becomes a highly reliable laser beam source device capable of emitting high-output laser beams.

Moreover, the first semiconductor laser element 12 is disposed on the flat surface 42a of the spherical base 42, and the second semiconductor laser element 13 is disposed on the upper surface 43b of the holding base 43 engaging with the spherical base 42. Thus, the entire size of the device can be reduced.

### Third Embodiment

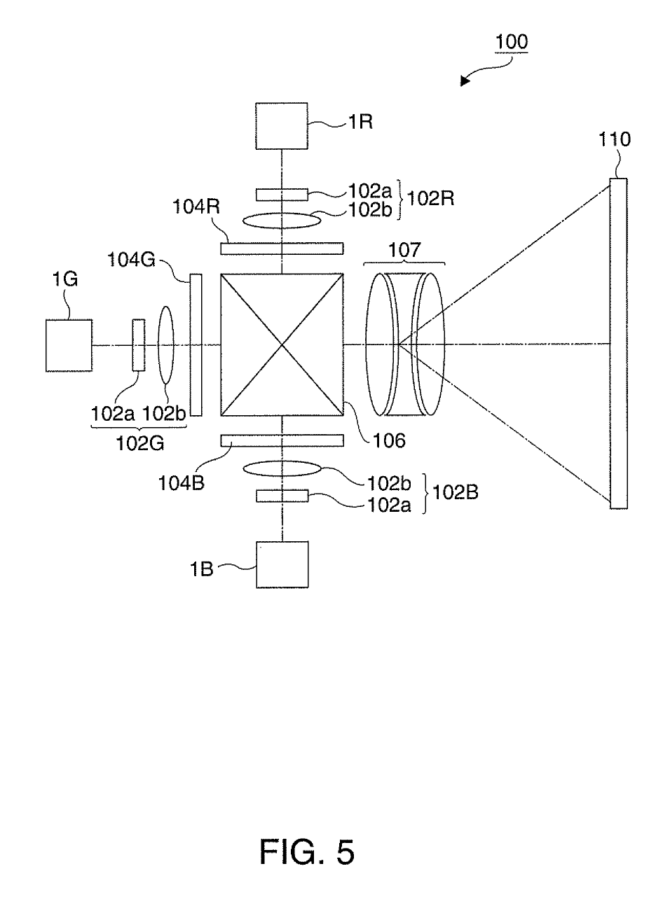

A third embodiment according to the invention is now described with reference to FIG. 5.

In this embodiment, a projector including the laser beam source device according to the first or second embodiment will be discussed. FIG. 5 illustrates the general structure of the projector in this embodiment.

A projector 100 according to this embodiment includes a red laser beam source device 1R for emitting red light, a green laser beam source device 1G for emitting green light, and a blue laser beam source device 1B for emitting blue light, each of which corresponds to the laser beam source device 1 or 40 according to the first or second embodiment.

The projector 100 includes transmission type liquid crystal light valves (light modulation devices) 104R, 104G, and 104B for modulating respective color lights emitted from the laser beam source devices 1R, 1G, and 1B, a cross dichroic prism (color combining unit) 106 for combining the lights received from the liquid crystal light valves 104R, 104G, and 104B and guiding the combined light to a projection lens 107, and the projection lens (projection unit) 107 for expanding an image formed by the liquid crystal light valves 104R, 104G, and 104B and projecting the expanded image on a screen 110.

The projector 100 further includes equalizing systems 102R, 102G, and 102B for equalizing illuminance distributions of the laser beams emitted from the laser beam source devices 1R, 1G, and 1B such that illumination lights having uniform illuminance distributions can be supplied to the liquid crystal light valves 104R, 104G, and 104B. In this embodiment, each of the equalizing systems 102R, 102G, and 102B contains a hologram 102a and a field lens 102b, for example.

The three color lights modulated by the respective liquid crystal light valves 104R, 104G, and 104B enter the cross dichroic prism 106. This prism is produced by affixing four rectangular prisms, and has a dielectric multilayer film for reflecting red light and a dielectric multilayer film for reflecting blue light disposed in a cross shape on the inner surfaces of the prisms. The three color lights are combined by these dielectric multilayer films to form light representing a color image. Then, the combined light is projected on the screen 110 by using the projection lens 107 as the projection system for display of the expanded image.

According to this embodiment, the projector 100 includes the red laser beam source device 1R, the green laser beam source device 1G, and the blue laser beam source device 1B each corresponding to the laser beam source device 1 or 40 according to the first or second embodiment. Thus, the projector 100 becomes a compact and low-cost projector capable of displaying bright images.

While the transmission-type liquid crystal light valves are used as the light modulation devices, the light modulation devices may be reflection-type light valves or light valves of types other than the liquid crystal type. Examples of these light valves involve reflection-type liquid crystal light valves and digital micromirror devices. The structure of the projection system is changed according to the types of light valves to be used.

### Fourth Embodiment

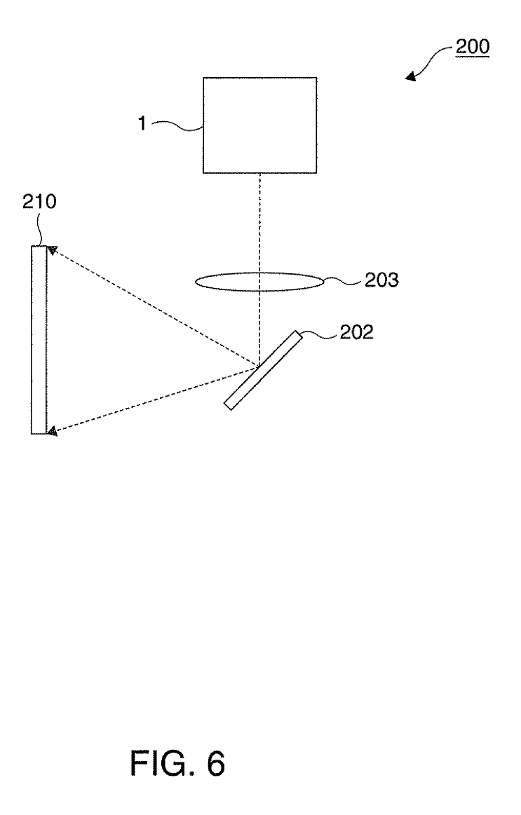

A fourth embodiment according to the invention is now described with reference to FIG. 6.

In this embodiment, a scanning-type image display apparatus will be discussed. FIG. 6 illustrates the general structure of the image display apparatus according to this embodiment.

As illustrated in FIG. 6, an image display apparatus 200 in this embodiment includes the laser beam source device 1 according to the first embodiment, an MEMS mirror (scanning unit) 202 which applies light emitted from the laser beam source device 1 toward a screen 210 for scanning, and a converging lens 203 for converging the light emitted from the laser beam source device 1 on the MEMS mirror 202. The light emitted from the laser beam source device 1 is applied to the screen 210 in the horizontal direction and the vertical direction for scanning by driving the MEMS mirror 202. For display of color images, plural emitters contained in laser diodes are constituted by combinations of emitters having peak wavelengths in red, green, and blue, for example,

In this embodiment, the laser beam source device 40 according to the second embodiment may be used.

### Fifth Embodiment

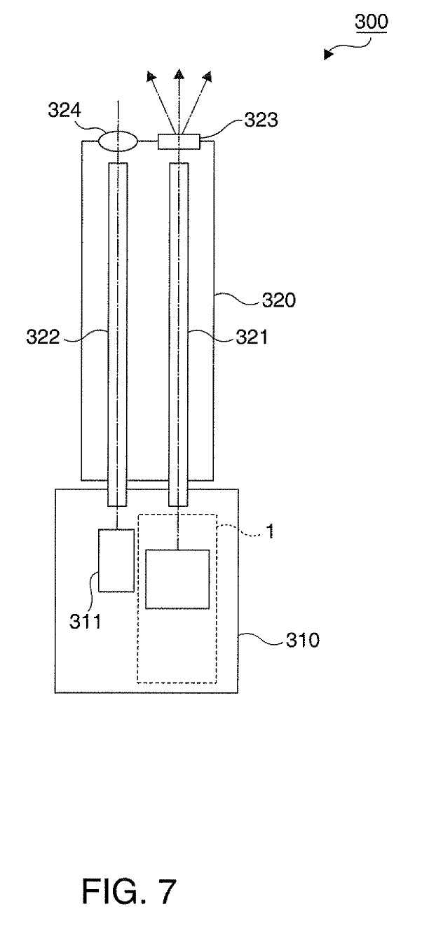

A structure example of a monitoring device 300 which uses the laser beam source device 1 according to the embodiment is now described with reference to FIG. 7.

FIG. 7 illustrates the general structure of the monitoring device according to this embodiment.

As illustrated in FIG. 7, the monitoring device 300 in this embodiment includes a device main body 310 and a light transmitting unit 320. The device main body 310 contains the laser beam source device 1 according to the first embodiment.

The light transmitting unit 320 includes two light guides 321 and 322 on the light sending side and the light receiving side, respectively. Each of the light guides 321 and 322 is produced by binding a number of optical fibers and can transmit laser beams to a distant place. The laser beam source device 1 is provided on the light entrance side of the light guide 321 for sending light, and a diffusion plate 323 is disposed on the light exit side of the light guide 321. The laser beam emitted from the laser beam source device 1 is transmitted to the diffusion plate 323 provided at the end of the light transmitting unit 320 via the light guide 321, diffused by the diffusion plate 323, and applied to a subject.

An image forming lens 324 is equipped at the end of the light transmitting unit 320 such that reflection light from the subject can be received by the image forming lens 324. The received reflection light is transmitted via the light guide 322 on the light receiving side to a camera 311 as an image pickup unit provided within the device main body 310. As a result, an image corresponding to the light reflected by the subject can be captured by the camera 311 by using the laser beam emitted from the laser beam source device 1 and applied to the subject.

According to this embodiment, the monitoring device 300 includes the laser beam source device 1 in the first embodiment. Thus, the monitoring device 300 becomes a compact and low-cost device capable of capturing clear images.

In this embodiment, the laser beam source device 40 according to the second embodiment may be used.

The technical range of the invention is not limited to the embodiments described herein but may be modified in various ways without departing from the scope and spirit of the invention. For example, the specific structures of the first and second semiconductor laser elements, the BPF, and the wavelength converting elements included in the laser beam source devices in the first and second embodiments are not limited to those shown herein but may be varied as necessary.

While the cross dichroic prism is used as the color combining unit in the projector, the color combining unit may be other units such as a unit for combining color lights by using dichroic mirrors disposed in a cross shape, and a unit for combining color lights by using dichroic mirrors disposed in parallel with each other.

The second semiconductor laser element may be disposed on a flat surface of another spherical component similarly to the first semiconductor laser element.

While the dividing units divide entering light by both transmission and reflection, the dividing units may divide light only by either transmission or by reflection.

The entire disclosure of Japanese Patent Application No. 2009-269667, filed Nov. 27, 2009 is expressly incorporated by reference herein.

What is claimed is:

1. A laser beam source device comprising:
a first light emission element which has a light emission portion for emitting a laser beam;
a second light emission element which has a light emission portion for emitting a laser beam, the first light emission element and the second light emission element are disposed such that light emitted from the light emission portion of each of the first and second light emission elements enter the light emission portion of the other light emission element;
a control member which has a flat surface on which the first light emission element is disposed and a curved surface having a convexed part; and
a holding member which has a concaved portion formed in correspondence with the curved surface for engagement between the concaved portion and the control member.

2. The laser beam source device according to claim 1, further comprising:
a supporting member on which the second light emission element is disposed; and
a space member which allows the first light emission element and the second light emission element to be disposed opposed to each other and maintains a predetermined distance between the first light emission element and the second light emission element.

3. The laser beam source device according to claim 2, wherein the space member achieves fine adjustment of the distance between the first light emission element and the second light emission element.

4. The laser beam source device according to claim 1, further comprising a dividing unit which releases a part of entering laser beams in a direction different from directions toward the first light emission element and the second light emission element and releases the remaining part of the laser beams in directions toward the first light emission element and the second light emission element.

5. The laser beam source device according to claim 1, further comprising a wavelength converting element which receives laser beams having a fundamental wavelength and emitted from the first light emission element and the second light emission element, and converts at least a part of the laser beams having the fundamental wavelength into laser beams having a predetermined converted wavelength.

6. The laser beam source device according to claim 5, wherein
the dividing unit has a first dividing unit disposed on an optical path between the first light emission element and the wavelength converting element and a second dividing unit disposed on an optical path between the second light emission element and the wavelength converting element; and
the first and second dividing units release the laser beams converted into laser beams having the predetermined converted wavelength in directions different from directions toward the first light emission element and the second light emission element, and release the laser beams not converted into laser beams having the predetermined converted wavelength in directions toward the first light emission element and the second light emission element.

7. A projector comprising:
the laser beam source device according to claim 1;
a light modulation device which modulates a laser beam emitted from the laser beam source device according an image signal; and
a projection device which projects a laser beam modulated by the light modulation device.

8. A monitoring device, comprising:
the laser beam source device according to claim 1; and
an image pickup unit which captures an image of a subject by using a laser beam emitted from the laser beam source device.
